(19) United States
(12) Patent Application Publication
(10) Pub. No.: US 2019/0210206 A1
(43) Pub. Date: Jul. 11, 2019

(54) MULTI-PURPOSE MEDICAL TOOL

(71) Applicant: Wayne D. NIX, Youngsville, LA (US)

(72) Inventor: Wayne D. NIX, Youngsville, LA (US)

(21) Appl. No.: 16/301,751

(22) PCT Filed: May 23, 2017
(86) PCT No.: PCT/US2017/034008

§ 371 Date: Nov. 15, 2018

Related U.S. Application Data
(60) Provisional application No. 62/467,730, filed on Mar. 6, 2017.
(60) Provisional application No. 62/356,273, filed on Jun. 29, 2016.
(60) Provisional application No. 62/339,975, filed on May 23, 2016.

(51) Int. Cl. B25F 1/00; B26B 13/22; B25F 1/04; B25B 7/08; B25B 7/14; B25B 7/22

(52) U.S. Cl. CPC B25F 1/003; B26B 13/22; B25B 7/22; B25B 7/08; B25B 7/14; B25F 1/04

(57) ABSTRACT

A medical tool comprising a first arm and a second arm attached at a pivot, a proximal clamp on a proximal side of the pivot, a distal clamp on a distal side of the pivot, and a first and a second distal tang blade spacing the distal clamp from the pivot.

### CROSS REFERENCE TO RELATED APPLICATIONS/PRIORITY

The present invention claims priority to U.S. Provisional Patent Application No. 62/339,975 filed May 23, 2016, U.S. Provisional Patent Application No. 62/356,273 filed Jun. 29, 2016, and U.S. Provisional Patent Application No. 62/467,730 filed Mar. 6, 2017, each of which is incorporated by reference into the present disclosure as if fully restated herein. Any conflict between the incorporated material and the specific teachings of this disclosure shall be resolved in favor of the latter. Likewise, any conflict between an art-understood definition of a word or phrase and a definition of the word or phrase as specifically taught in this disclosure shall be resolved in favor of the latter.

### BACKGROUND OF THE INVENTION

Medical professionals require multiple tools to perform their tasks, many times needing specific tool functionality on very quickly or immediately. Previous attempts to combine tool functionality may have increased risk of inadvertently damaging tubes or materials clamped. For the foregoing reasons, there is a pressing, but seemingly irresolvable need for a safe, robust, multi-function medical tool.

### SUMMARY OF THE INVENTION

Wherefore, it is an object of the present invention to overcome the above mentioned shortcomings and drawbacks associated with the current technology. The present invention is directed to methods and apparatuses that satisfy the above shortcomings and drawbacks. The methods and apparatus relate to a medical tool comprising a first arm and a second arm attached at a pivot, a proximal clamp on a proximal side of the pivot, a distal clamp on a distal side of the pivot, and a first and a second distal tang blade spacing the distal clamp from the pivot. According to a further embodiment, a terminal blade protrudes on a distal end of one of the first arm, the second arm, and both the first and the second arm. According to a further embodiment, a recessed knife attaches to a hip, the hip being adjacent one of a first finger handle, a second finger handle, and both the first and the second finger handle. According to a further embodiment, the distal clamp includes a first jaw on the first arm and a second jaw on the second arm, with each of the first and second jaw at least partially contacting one another when the medical tool is in a closed position. According to a further embodiment, the distal clamp includes a first housing grasp on the first arm and a second housing grasp on the second arm, with each of the first and second jaw at least partially contacting one another when the medical tool is in a closed position. According to a further embodiment, the first and second housing grasp form a quadrilateral shaped grasp aperture. According to a further embodiment, the distal clamp further comprises a first housing grasp on the first arm and a second housing grasp on the second arm, with each of the first and second jaw at least partially contacting one another when the medical tool is in a closed position. According to a further embodiment, one of distal and proximal portions of one of the first and second arms contains a graduated first surface display to aid in measurement. According to a further embodiment, one of the distal and proximal portions of the first arm contains a graduated first surface display to aid in measurement, and one of the distal and proximal portions of the second arm contains a graduated second display to aid in measurement. According to a further embodiment, a vial opener is disposed on one of the first and the second arms. According to a further embodiment, one of a gas cylinder wrench, a hex bit adaptor, and both the gas cylinder wrench and the hex bit adapter are defined in a proximal region of one of the first and the second arms. According to a further embodiment, one of a first shield, a second shield, and the first and the second shield are on a distal region of one of the first and the second arms to aid in preventing inadvertently shearing a material being clamped by the distal clamp. According to a further embodiment, the shield blocks material from the entering between the distal tang blades until the medical tool is opened past a minimum cutting angle. According to a further embodiment, a catch releasable retains the medical tool in a closed position. According to a further embodiment, the catch comprises a catch arm attached to the first arm that engages a bar attached to the second arm in a catch arm recess. According to a further embodiment, the catch comprises a pair of locking arms with one or more releasably interlocking ratchets on each locking arm. According to a further embodiment, a one of bite walls, angular wrench housing, and both bite walls and angular wrench housing are disposed on respective inferior and superior surfaces of the first and second arms on the proximal side of the pivot. According to a further embodiment, a medial open wrench is defined in one of the first and second arms with contours to engage a plurality of nut sizes.

The invention further relates to methods and medical tool comprising a first arm and a second arm attached at a pivot, a distal clamp on the first and second arm on a distal side of the pivot, a first and a second distal tang blade spacing the distal clamp from the pivot, and a first shield on the first arm spaced between the distal clamp and the first distal tang blade, the first shield aiding in preventing inadvertently shearing a material being clamped by the distal clamp.

The present invention also relates to handheld medical tools that open, cut, clamp, and grip work objects.

Further alternative embodiments include the following. The arms could be hollow in nature allowing for articles to be stored within. The arms could be made of material to allow for increased buoyancy (floatation if the medical tool is dropped in a water environment). The arms could allow for a cord to run through like a rubber wrench/grasping device. The arms may be configured store tapes. The arms could house fluids like antiseptic dispersed by a spray attachment, or combustibles like lighter fluid.

The jaws could have angular groves on the outer edges assisting with tying of knots. The angular grooves may be of sufficient depth to hold a loop of a suture line as the jaws are actuated within the loop of suture line. The distal noses could be configured to receive different types of drivers, including bit driver connectors such as a hex bit. The distal noses could have a hooked blade for ripping. The distal noses could have a side/lateral material lift/scoop, similar to bandage shears. The distal noses could have notches that act as suture extracting tips.

The distal tangs could house folding bit receivers. The distal tangs could be interchangeable or at least partially disposable, with ejectable blades that can be changed out. The distal tangs could include a ring cutter.

The pivot could be a rivet, a screw, spring loaded, and different types of fasteners.

The curved shanks could have an adjustable worm screw. The curved shanks could have a ratchet head key hold to hold other devices.

There could be a second recessed knife and clasp on the same or different arm.

A light may be included, including a battery and switch. The light could be detachable, connected to a threaded stem. It could also snap on or screw on to a receiver on one of both of the arms.

A carabiner may be rotatably attached to the finger handles and maybe configured to lock. A Taylor reflex hammer may be attached to one of the finger handles.

Various objects, features, aspects, and advantages of the present invention will become more apparent from the following detailed description of preferred embodiments of the invention, along with the accompanying drawings in which like numerals represent like components. The present invention may address one or more of the problems and deficiencies of the current technology discussed above. However, it is contemplated that the invention may prove useful in addressing other problems and deficiencies in a number of technical areas. Therefore the claimed invention should not necessarily be construed as limited to addressing any of the particular problems or deficiencies discussed herein.

### BRIEF DESCRIPTION OF THE DRAWINGS

The accompanying drawings, which are incorporated in and constitute a part of the specification, illustrate various embodiments of the invention and together with the general description of the invention given above and the detailed description of the drawings given below, serve to explain the principles of the invention. It is to be appreciated that the while the accompanying drawings are drawn to scale, different scales of the various elements are within the principles of the invention. The invention will now be described, by way of example, with reference to the accompanying drawings in which:

FIG. 1 is a dexter side plan view of the medical tool of the present invention in a fully closed position, with the superior side to the top of the page, inferior side the bottom of the page, proximal side the left of the page, and distal side to the right of the page;

FIG. 2 is a sinister side plan view of the medical tool in FIG. 1, with the superior side to the top of the page, inferior side the bottom of the page, proximal side the right of the page, and distal side to the left of the page;

FIG. 3 is a partially exploded isometric view of the medical tool in FIG. 1, with the knife blade exposed;

FIG. 4 is a dexter side plan view of the medical tool of FIG. 1 in a fully open position;

FIG. 5 is a sinister side plan view of the medical tool of FIG. 1 in a fully open position;

FIG. 6 is a isometric view of the medical tool of FIG. 1 with the first and second arms detached from one another;

FIGS. 7A and 7B are close up partial views of a distal end of the first arm of the medical tool of FIG. 1;

FIGS. 7C and 7D are close up partial views of a distal end of the second arm of the medical tool of FIG. 1;

FIG. 8A is a close up isometric view of a proximal end of the first and second arm of the medical tool of FIG. 1, with a catch in a closed position;

FIG. 8B is a close up isometric view of the pivot of the medical tool of FIG. 1, with the first and second arm detached from one another;

FIGS. 9A-9F are close up partial views of various alternative embodiments of the housing graps of the medical tool of FIG. 1;

FIGS. 10A and 10B are close up partial views of various further alternative embodiments of the housing graps of the medical tool of FIG. 1;

FIG. 10C close up partial isometric view of an alternative embodiment of second distal tang and second cutting edge:

FIGS. 11A-11G are close up partial vies of various alternative embodiments for distal ends of the medical tool of FIG. 1, where FIG. 11A has a flat blade on the first arm, FIG. 11B has a bunt tip, where FIGS. 11D and 11E are close up view of the second and first distal ends of the medical tool in FIG. 11B, FIG. 11C is a hooked blade on the second arm, FIG. 11F is a bit driver insertable tip on the second arm, and FIG. 11G is a slide material lift on the second arm;

FIG. 12 is side plan view of an alternative embodiment of the medical tool having a stationary or folding bit receiver on the distal end of the second arm and a bit insert on the proximal end of the second arm;

FIGS. 13A-13F are close up partial views of alternative embodiments for the distal ends of the medical tool of FIG. 1, each with one of suture extracting and knot typing distal tips;

FIGS. 14A and 14B are isometric views of a further embodiment of the medical tool with a locking arms for the catch; and

FIGS. 15A and 15B are additional isometric views of the medical tool in FIGS. 14A and 14B.

### DETAILED DESCRIPTION OF THE PREFERRED EMBODIMENTS

The present invention will be understood by reference to the following detailed description, which should be read in conjunction with the appended drawings. It is to be appreciated that the following detailed description of various embodiments is by way of example only and is not meant to limit, in any way, the scope of the present invention. In the summary above, in the following detailed description, in the claims below, and in the accompanying drawings, reference is made to particular features (including method steps) of the present invention. It is to be understood that the disclosure of the invention in this specification includes all possible combinations of such particular features, not just those explicitly described. For example, where a particular feature is disclosed in the context of a particular aspect or embodiment of the invention or a particular claim, that feature can also be used, to the extent possible, in combination with and/or in the context of other particular aspects and embodiments of the invention, and in the invention generally. The term “comprises” and grammatical equivalents thereof are used herein to mean that other components, ingredients, steps, etc. are optionally present. For example, an article “comprising” (or “which comprises”) components A, B, and C can consist of (i.e., contain only) components A, B, and C, or can contain not only components A, B, and C but also one or more other components. Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range beginning with that number (which may be a range having an upper limit or no upper limit, depending on the variable being defined). For example “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40% means 40% or less than 40%. When, in this specification, a range is given as “(a first number) to (a second number)” or “(a first number)−(a second number),” this means a range whose lower limit is the first number and whose upper limit is the second number. For example, 25 to 100 mm means a range whose lower limit is 25 mm, and whose upper limit is 100 mm. The embodiments set forth the below represent the necessary information to enable those skilled in the art to practice the invention and illustrate the best mode of practicing the invention. In addition, the invention does not require that all the advantageous features and all the advantages need to be incorporated into every embodiment of the invention.

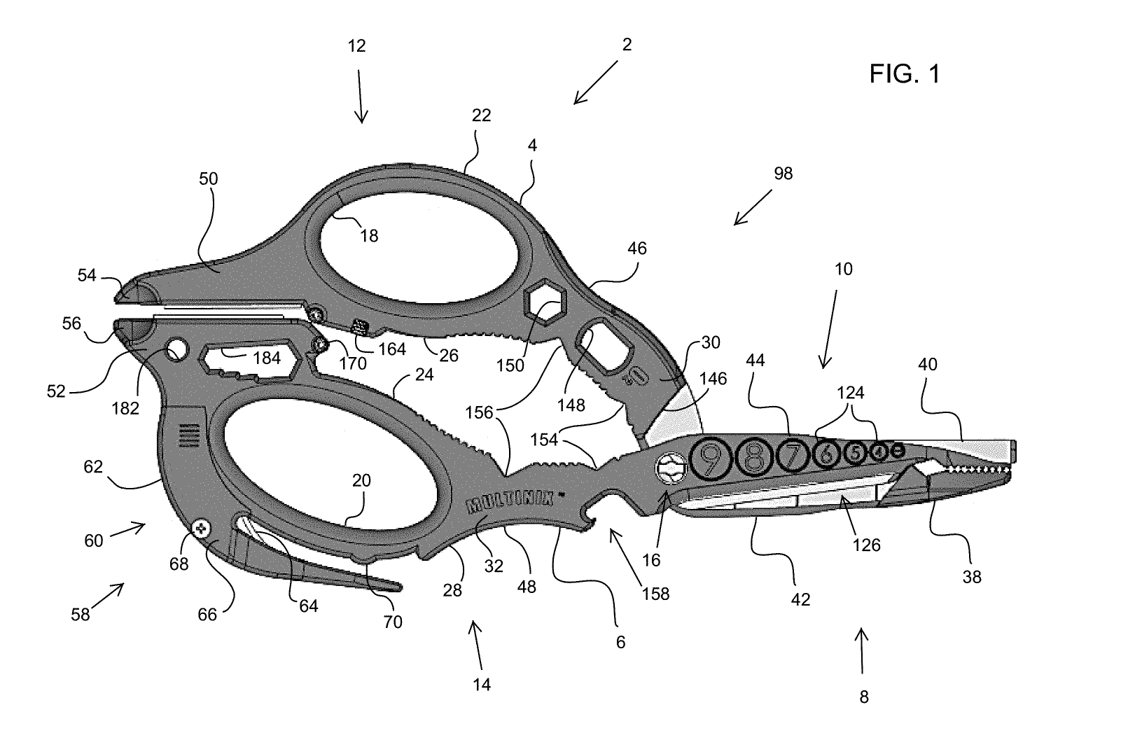

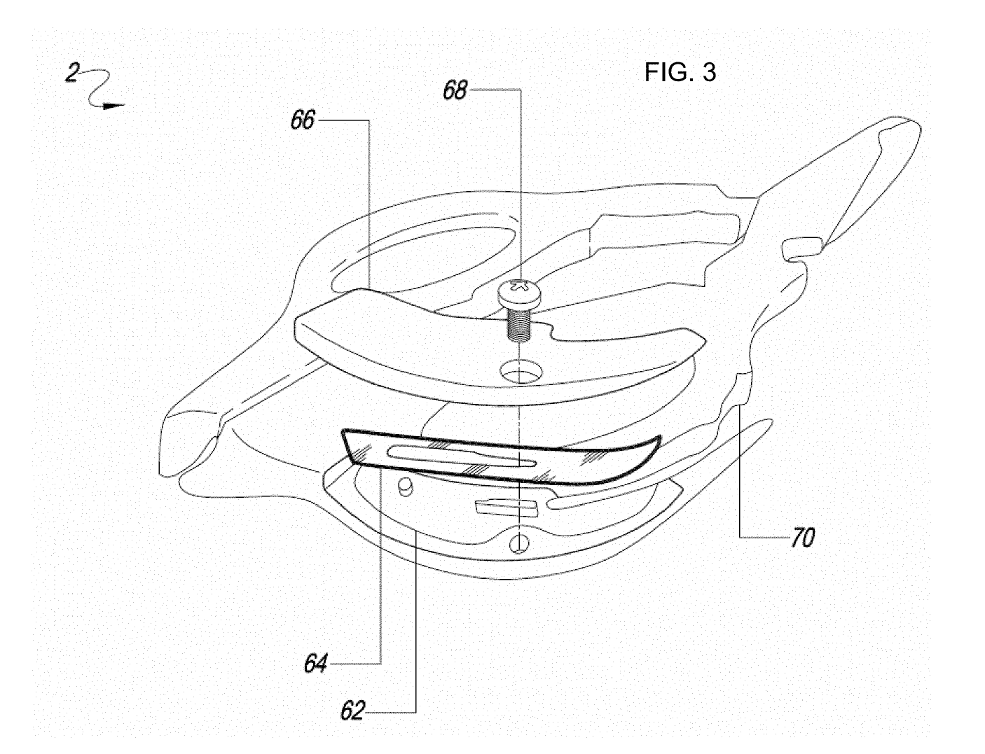

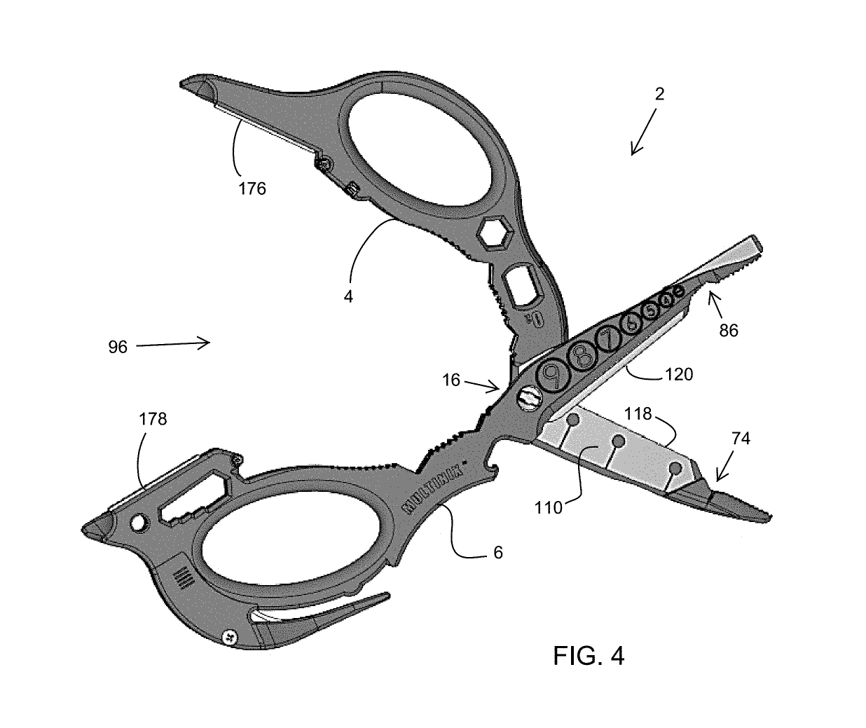

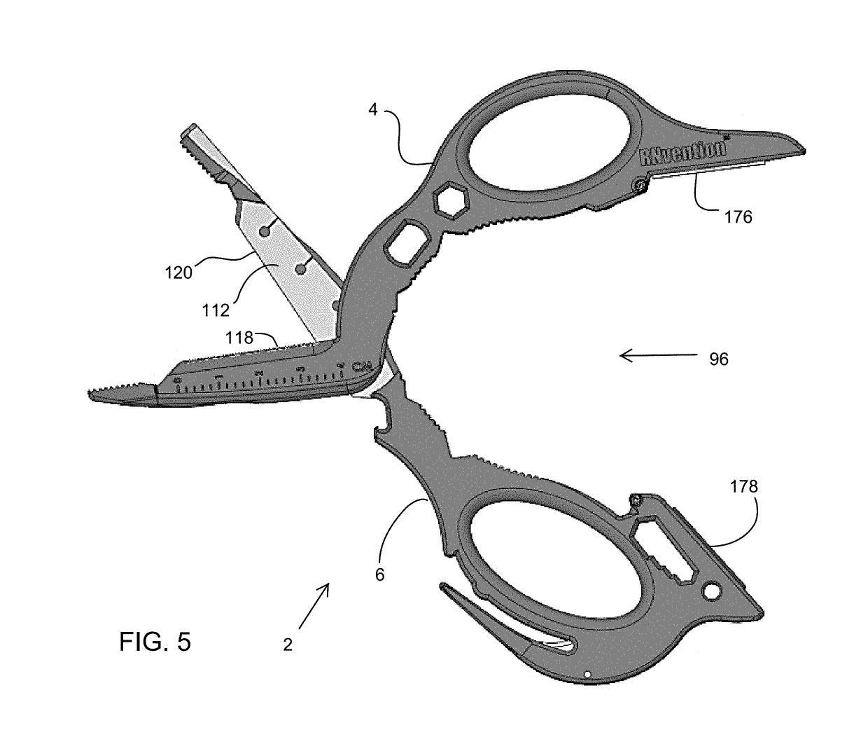

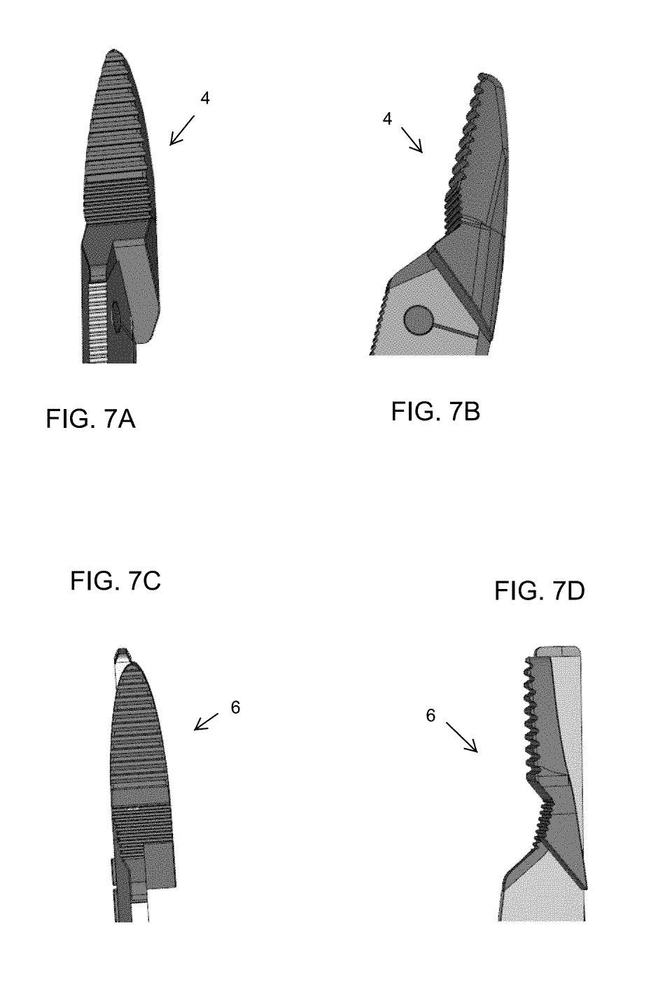

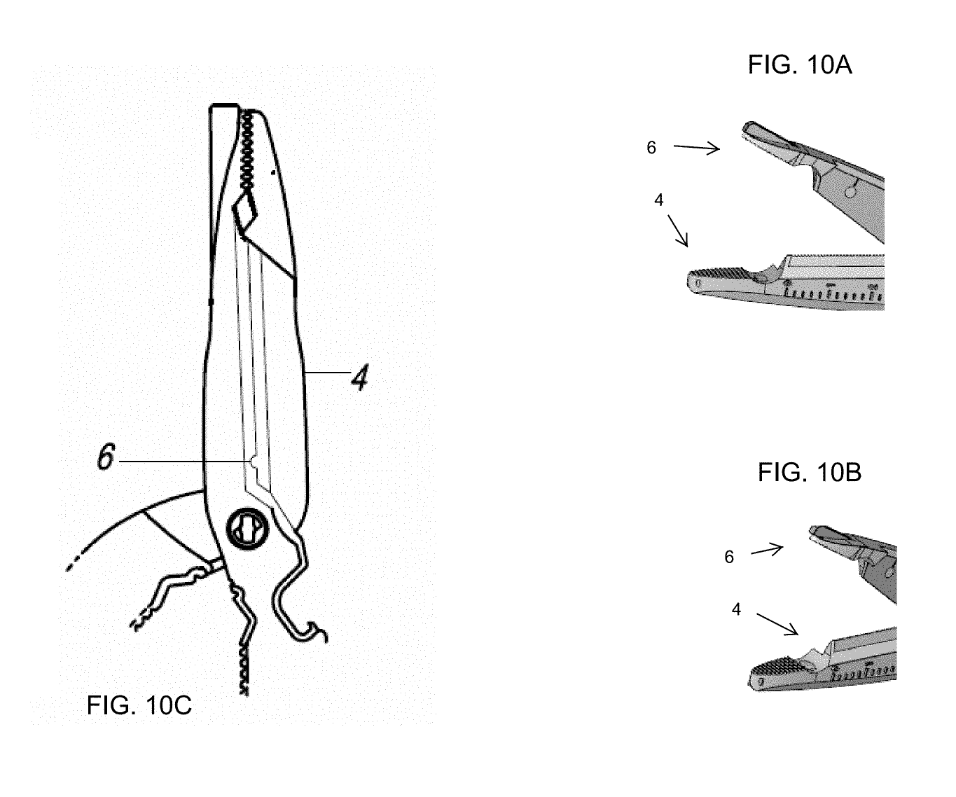

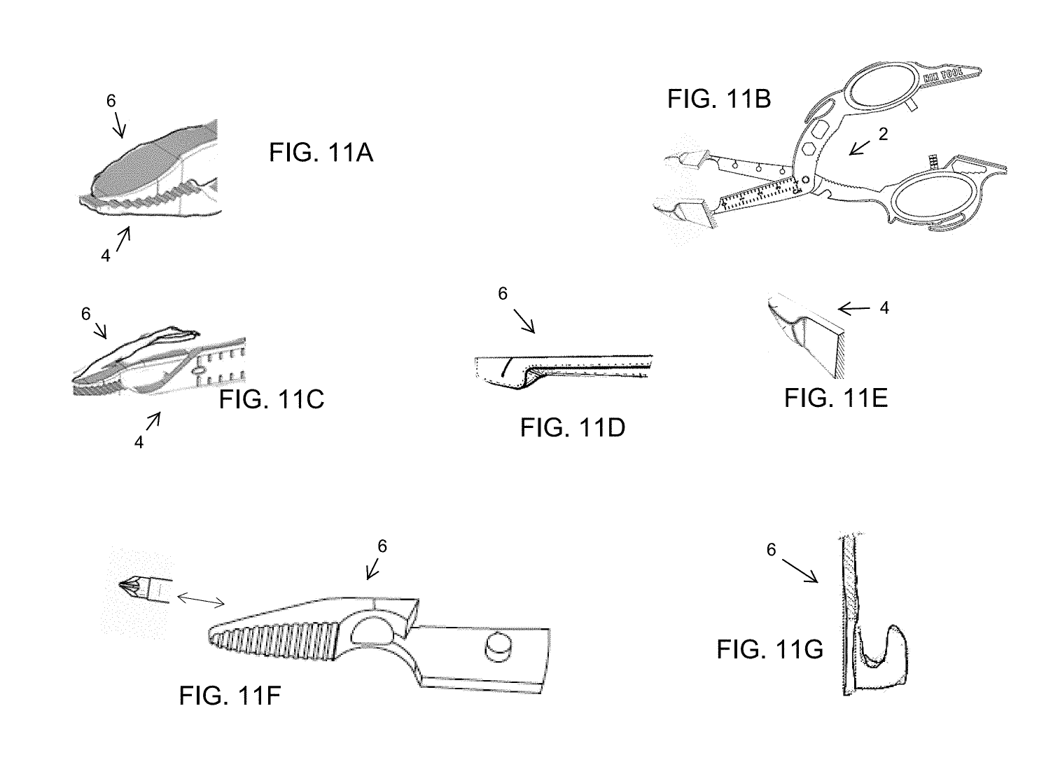

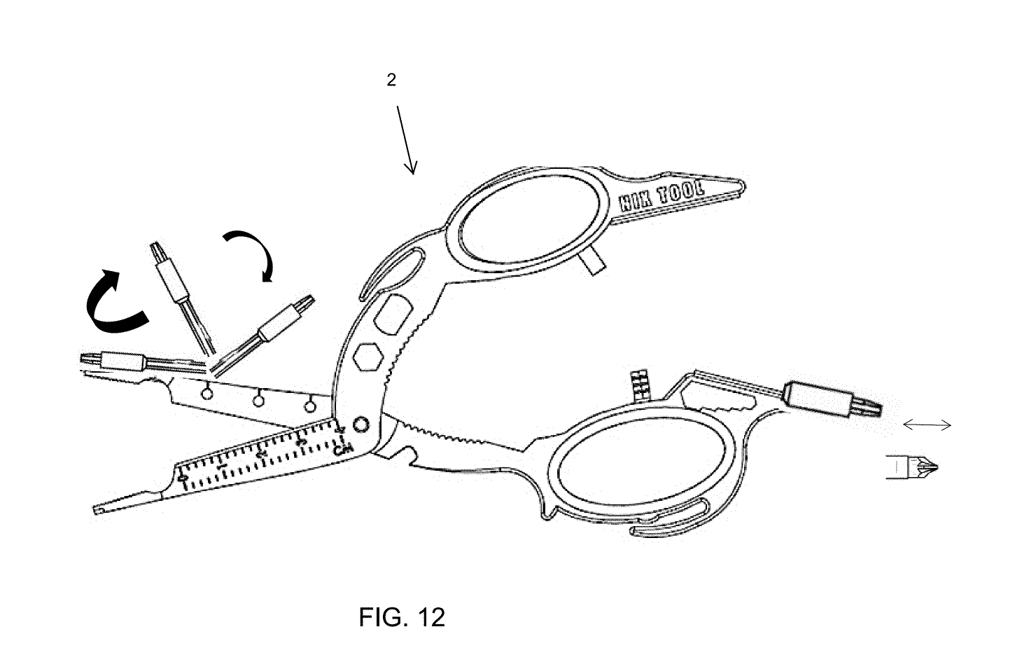

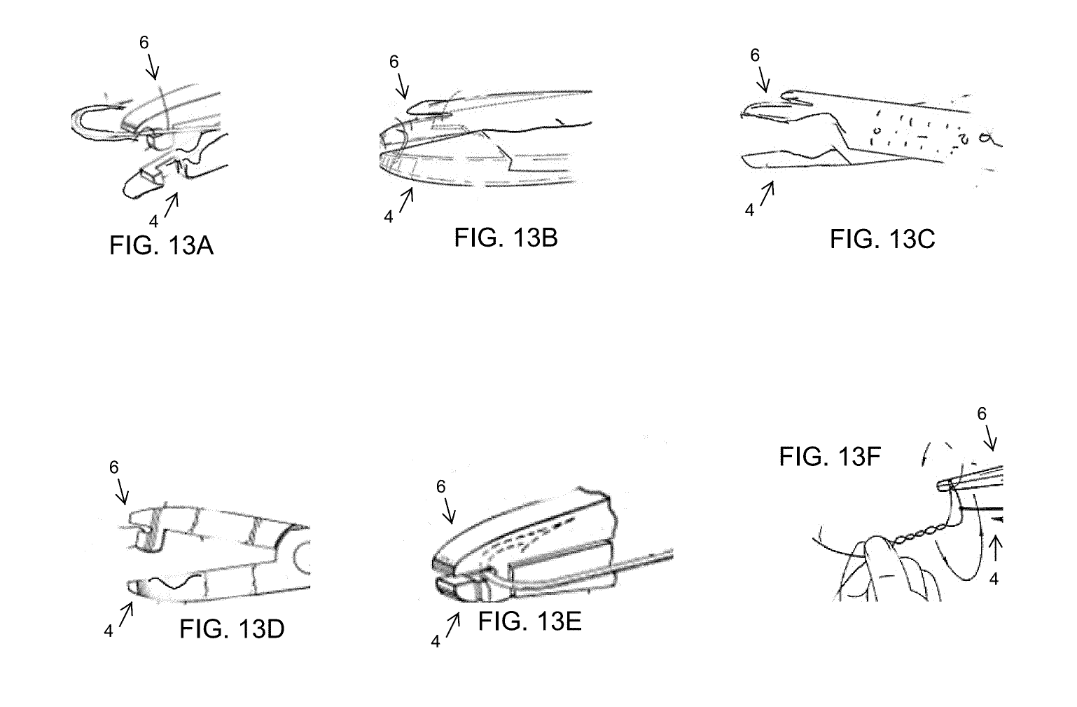

Turning now to FIGS. 1-15B, a brief description concerning the various components of the present invention will now be briefly discussed. As can be seen in the embodiment shown in FIGS. 1-5, the medical tool 2 has a first arm 4 and second arm 6, with a respective first distal region 8 and second distal region 10 and a respective first proximal region 12 and second proximal region 14. The distal regions 8, 10 on each arm 4, 6 are offset from the proximal regions 12, 14 by a pivot 16.

At the pivot 16, the first arm 4 and the second arm 6 are rotatably interlocked, such that the two arms 4,6 are closely adjacent and allowed to open and close upon actuation of respective first and second finger handles 18, 20.

The first and second arms 4, 6 have respective first and second superior surfaces 22, 24, first and second inferior surfaces 26, 28, first and second dexter surfaces 30, 32, and first and second sinister surfaces 34, 36. If a user was holding the medical tool 2 with her thumb through the first finger handle 18 and fingers through the second finger handle 20, with the tool arranged so that the distal regions 8, 10 were pointing away from her with the second distal region 10 substantially parallel to the ground, and the first finger handle 18 is above the second finger handle 20, then preferably the distal regions 8, 10 will be further from the user than the proximal regions 12, 14, the superior surfaces 22, 24 will be facing up, toward the user's head, and the inferior surfaces 26, 28 will be facing down, away from the user's head, the dexter surfaces 30, 32 will be facing toward the user's right, and the sinister surfaces 34, 36 will be facing toward the user's left.

The first and second distal regions 8, 10 of the medical tool 2 contain respective first and second distal noses 38, 40 and first and second distal tangs 42, 44.

The first and second proximal regions 12, 14 of the tool 2 contains respective first and second curved shanks 46, 48, first and second finger handles 18, 20, first and second elongated tangs 50, 52, and first and second proximal noses 54, 56. The second proximal region 14 includes a hip 58, with a recessed knife 60. The recessed knife 60 has a knife housing 62, a knife blade 64, a knife housing plate 66, a retainer 68, such as a screw, and a clasp 70.

Distal Noses: As shown in FIGS. 1-5, the distal noses will be discussed in further detail. Moving in a proximal direction from the distal tip of the first distal region 8, the first distal nose 38 includes a first jaw 72, a first housing grasp 74, and ends with a first shield 76. The first distal nose 38 is preferably elongate, and preferably wider than the first and second distal tangs 42, 44. The first distal nose 38 preferably has a smooth and gently tapered first inferior surface 26, and has a roughened first superior surface 22 defining the first jaw 72. A primary first housing grasp angle 78 and a secondary first housing grasp angle 80 are recessed into the first distal region 8 and form the first housing grasp 74. The first housing grasp 74 transitions to the first shield 76.

Moving in a proximal direction from the tip of the second distal region 10, the second distal nose 40 includes a protruding and preferably flat terminal blade 82, a second jaw 84, a second housing grasp 86, and ends with a second shield 88. The second distal nose 40 is preferably elongate, and preferably wider than the first and second distal tangs 42, 44. A roughened second inferior surface 28 defines a second jaw 84. A primary second housing grasp angle 90 and a secondary second housing grasp angle 92 form the second housing grasp 86. The second housing grasp 86 transitions to the second shield 88. The first and second jaws 72, 84 and the first and second housing grasps 74, 86 form a plurality of distal clamps.

The terminal blade 82 preferably protrudes approximately 0.019 inches in the distal direction and 0.172 inches in the superior direction past the second jaw 84, though such measurements could vary by 10%, 25%, and 50% larger or smaller for example and by 100% or larger for example. The terminal blade 82 preferably has a tapered leading edge 94 to enable insertion into surfaces, and manipulation at various angles while still maintaining maximum contact between the surfaces of the terminal blade 82 and the objected being worked upon. The user may preferably control the angle, depth, direction and force of leading edge 94 of the terminal blade 82 by directly gripping an outer surface of the first and second distal tangs 42, 44—being the first sinister and first inferior surfaces 34, 26 and the second dexter and second superior surfaces 32, 24—or by controlling the medical tool 2 with the finger handles 18, 20 or other locations on the medical tool 2, while the medical tool 2 is in either an open position 96 or preferably a closed position 98. The terminal blade 82 extending beyond the second jaw 84 allows the terminal blade 82 to be inserted into a screw head and to be used to split pills in packages, for example.

The medical tool 2 is preferably comprised of metal, unitary of construction, first and second core portions 100, 102. The terminal blade 82 is preferably part of and unitary of construction with the second core portion 102. The first and second core portions are preferably encased in first and second encasings 104, 106, which are preferably comprised of plastic, unitary of construction. The first and second encasings 104, 106 may also be made of a same or different metal than the core portions 100, 102, and may also be of unitary construction with respective first and second core portions 100, 102. The first and second jaws, 72, 84, housing grasps 74, 86, and shields 76, 88 are preferably formed by first and second encasing portions 104, 106 extending beyond the first and second core portions 100, 102 in respective superior and inferior directions. A preference is that the material the medical tool 2 is constructed of allows the medical tool 2 to sturdy enough to be reliable, be autoclavable, while preferably not being so heavy as to weigh down the user or drag on other medical equipment that the medical tool 2 is attached to.

The first and second jaws 72, 84 preferably have a substantially triangular shaped roughed surface, with a wider proximate end and a preferably blunted, more narrow distal end. The jaws, span approximately ⅛ to 1/12 the length of the arms 4, 6, and preferably approximately ¼ the length of the distal regions 8, 10. The jaws 72, 84 allow the user to grip an object with the first superior surface 22 of the first jaw 72 and the second inferior surface 28 of the second jaw 84, when the first and second arms 4, 6 are actuated towards each other moving from the open position 96 to the closed position 98. At least a portion of the first superior surface 22 of the first jaw 72 and the second inferior surface 28 of the second jaw 84 are preferably directly adjacent when the medical tool is in the closed position 98.

The first and second distal noses 38, 40 include the first and second housing grasps 74, 86. The housing grasps 74, 86 define a grasp aperture 108 from a dexter or sinister side view in first and second distal noses 38, 40 when the first superior surface 22 of the first jaw 72 and the second inferior surface 28 of the second jaw 84 are positioned adjacent to one another. In the closed position 98, the primary first housing grasp angle 78, the secondary first housing grasp angle 80, the primary second housing grasp angle 92, and the secondary second grasp angle 92 form a quadrilateral shaped grasp aperture 108, including trapezium, trapezoid, isosceles trapezoid, parallelogram, rhombus, rhomboid, rectangle, square, oblong, and kite shapes for example. The housing grasps 74, 86 may have all surfaces textured, all surfaces smooth, or as in the embodiment shown, some of the surfaces textured and some of the surfaces smooth. In the embodiment shown, the primary first and secondary second housing grasp angles 78, 92 have smooth engaging surfaces, and the secondary first and primary second housing grasp angles 80, 90 have textured engaging surfaces. Though a four-sided polygon is preferred, the grasp aperture 108 shape maybe a three, five, six, seven, or eight-sided polygon, a circle, a semicircle, a non-circular ellipse, a non-circular simi-ellipse, or some combination thereof. A user may grip contoured object with the housing grasps 74, 86, while control grasping pressure between the of the objects being grasped. The housing grasps 74, 86, further allows for grasping medical tubes with a preferable shape that disperses pressure to allow for less cracking of tubes.

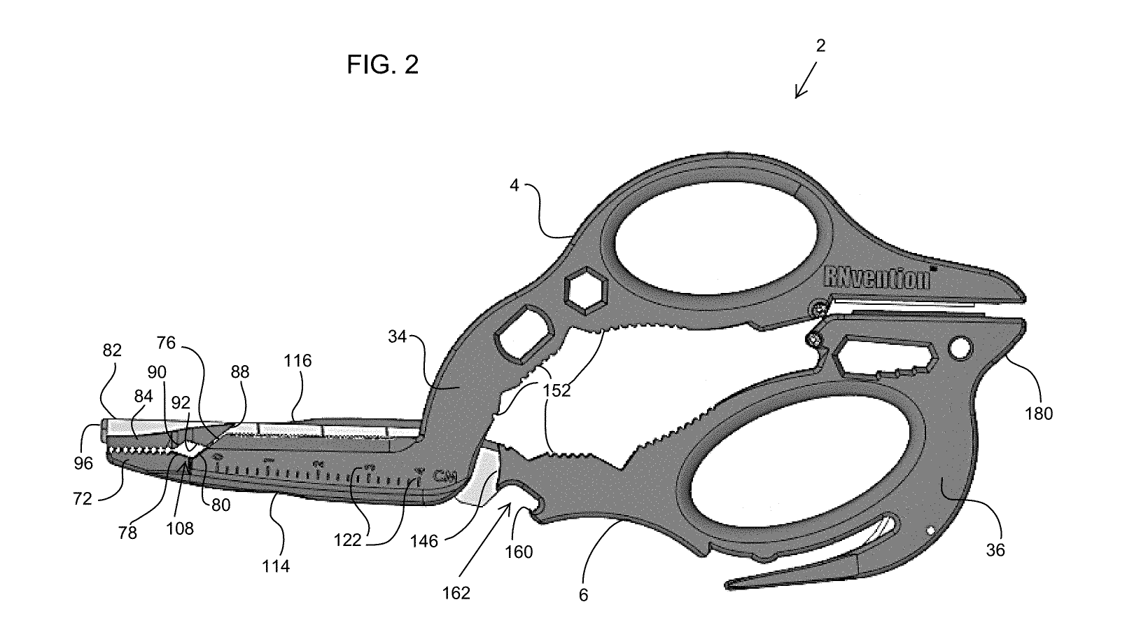

The first and second shields 76, 82 are located proximal to the housing grasps 74, 86. The shields 76, 82 serve as a visual reference and a physical barrier to the user, and aids in protecting an object from inadvertent cutting, when the user is attempting to grip the object with the jaws 72, 84 or the housing grasp 74, 86. In the embodiment shown, the first shield 76 extends proximally and superiorly from the first housing grasp 74 at substantially the same angle as the secondary first housing grasp angle 80 up to the first superior surface 22 of the first distal tang 42. The second shield 88 extends proximally and inferiorly from the second housing grasp 86 at substantially different angle as the secondary second housing grasp angle 92 down to the inferior surface of the second distal tang 44. As seen in FIGS. 1 and 2 when the tool is in a closed position 98, the first and second 76, 88 slide adjacent to one another. The shields 76 88, preferably require the medical tool 2 to be opened beyond a minimal cutting angle to access the first and second distal tang blades 110, 112. The minimal cutting angle is preferably 1.0-20.0% larger, more preferably 5.0-10.0% than an angle required to open the medical tool 2 wide enough to allow an object into the grasp aperture 108 that would substantially fully fill the grasp aperture 108 when the medical tool 2 is closed.

Distal Tangs: Returning to FIGS. 1-5, the first and second distal tangs 42, 44 are shown. The distal tangs 42, 44 preferably have both a cutting and measurement functionality. The distal tang 42, 44 arms are approximately half of the width in the dexter/sinister directions as a maximum width of the distal noses 38, 40. The first and second distal tangs 42, 44 and have respective inferior and superior contoured surface finger impressions 114, 116. The first and a second distal tangs 42, 44 are preferably elongate in the proximal/distal direction, of substantially consistent width in the dexter/sinister direction, and of increasing height in the inferior/superior direction moving from the distal noses 38, 40 to the pivot 16.

The dexter surface 30 of the first distal tang 42 and sinister surface 36 of the second distal tang 44 are preferably smooth with a first and second cutting edge 118, 120 on the distal tang blades 110, 112 formed, respectively, from the superior surface 22 of the first distal tang blade 110 and the inferior surface 28 of the second distal tang blade 112. The distal tang blades are preferably part of and unitary of construction with the core portions 100, 102. The first cutting edge 118 is preferably serrated and the second cutting edge 120 is preferably smooth, as in the embodiment shown, to allow for smooth cuts while also aiding in gripping material being cut, but both cutting edges 118, 120 could be smooth, or both serrated, or some combination of smooth and serrated.

The cutting edges 118, 120, may have a width of preferably between 0.040 inches to about 0.250 inches in the dexter/sinister direction. Increasing the width increases a cutting surface area and increases an effectiveness of cutting articulation, but potentially adds weight. Though the first and second distal tang blades 110, 112 have a substantially consistent width, further embodiments may have widths that vary along the proximal/distal length of the distal tang blades 110, 112.

Additionally, for example the first and second distal tangs may be widest proximate to cutting edges 118, 120, and narrower in the dexter/sinister directions when moving further away from the cutting edges 118, 120 in respective the inferior and superior directions. In this respect, the first and second arms 4, 6 may provide material relief during cutting and may further ensure that the first cutting edge 118 meets the second cutting edge 120.

Preferably, a plurality of materials may be cut by the distal tang blades 110, 112, including but not limited to materials such as clothing, bandages, paper, textiles, relatively thin metals, plastics etc.

When actuating the medical tool 2 to cut a material, e.g., moving the medical tool from the open position to the closed position, the cutting nip, being the intersection between the first cutting edge 118 and the second cutting edge 120, advances in the distal direction. The angle of the distal tang blades 110, 112 relative to one another is preferably lower such that the material being cut is less likely to be pushed away from the cutting nip.

The first cutting edge 118 is illustrated with the preferred embodiment and beveled such that the first cutting edge 118 is the apex of an acute angle and is formed at an inner edge of the first distal tang 42. The second cutting edge 120 is beveled such that the cutting nip is at the apex of an acute angle formed at an inner edge of the second distal tang 44.

Cutting occurs with the first cutting edge 118 engages a material through the opposing second cutting edge 120, advancing distally when two arms 4, 6 are actuated towards one another. The material cut, may be better griped with serrations on the cutting edges 118, 120. The amount or type of blade edge serrations may vary along the proximal/distal length of the cutting edges 118, 120. Additional, deeper, or more pronounced blade edge serrations may be formed on the cutting edges 118, 120 in locations closer to the hinge point or pivot 16 may be beneficial as, due to relatively large angle the arms 4,6 form relative to one another when opened far enough for the cutting nip to be located close to the pivot, the material is more likely to be pushed out of cutting nip. The changes in blade edge serrations with respect to length may be stepwise—abruptly changing from one constant type of serrations to a second constant type of serrations, linear—consistently changing from one type of serration to a second type of change, or geometric—an increasing rate of change from one type of serration to a second type of serration, for example. The advancing of the cutting nip enables a cut to be made progressively through a material that is disposed between the cutting edges 118, 120.

The first and/or second distal tang blades 110, 112 may have one or more curved or angled notches toward the proximal end of the distal tang blades for cutting thick tubes and/or striping wires.

The first and the second distal tangs preferably include respective first and second surface displays 122, 124 topographically contoured/formed into or on respective first sinister and second dexter surfaces 34, 32. The first surface display 122, for example, may display a ruled marking scale, for example displaying labeled 0 to 4 centimeter incremental markings by tenth or fifth of a centimeter. The second surface display, for example, may display circumferential millimeter markings, displaying, for example, labeled 3 to 9 mm incremental markings. The markings of the first surface display 122 allows for linear measurements such as wound healing approximation and the second surface display 124 allows for diameter measurements such as pupil dilation. The surface displays 122, 124 may additionally have phosphorescent or glow in the dark markings to aid in making measurements in low lighting hospital situations.

The curved inferior and superior contoured surface finger impressions 114, 116 allow a medical tool 2 user additional control and comfort when gripping the outside of the distal regions 8, 10 to direct the terminal blade 82, for example when gripping the medical tool 2 like a pencil to scrape with the terminal blade 82.

The first inferior surface 26 of the first distal tang 42 has a contoured surface to allow ease of sliding over surfaces, for example, when cutting bandages on the top of a sheet or a table.

In a preferred embodiment, in a closed position, the second cutting edge forms an acute angle with the first inferior surface 26 on the first distal tang 42, providing a blade visualization 126. This allows for better visualization of the cutting edges 118, 120 and increases the ease of cutting through thicker materials without sticking, such as gauze. The distal tangs 42, 44 may also be radiused for shearing.

Pivot: The pivot 16 preferably releasably rotatably attaches the first arm 4 to the second arm 6. The pivot includes a pivot protrusion 128 on the first arm and a pivot aperture on the second arm 6. The pivot protrusion has an elongate upper surface 132 and a narrow lower surface 134. The elongate upper surface 132 matches an elongate portion 136 of the pivot aperture 130. Preferably, when the medical tool 2 is opened to the greatest extent 96, the elongate upper surface 132 aligns with the elongate portion 136 of the pivot aperture 130 to allow the pivot protrusion 128 to slide into and out of the pivot aperture 130. When the pivot protrusion 128 is inserted fully into the pivot aperture 130 and the medical tool 2 is then moved toward the closed position 98, the elongate upper surface 132 will no longer align with the elongate portion 136 of the pivot aperture 130. The pivot protrusion 128 will be able to pivot within the pivot aperture 130, but will be retained by and no longer able to slide out of the pivot aperture 130 until the elongate upper surface 132 is again aligned with the elongate portion of the pivot aperture 136. When the pivot protrusion 128 is retained by the pivot aperture 130, the arms 4, 6 are closely adjacent and pivot one another about the pivot 16.

The pivot protrusion is preferably made of strong and durable material such as a metal, strong plastic, or ceramic. The pivot protrusion in the embodiment shown is of metal and of unitary construction with the first core portion 100. The elongate upper surface in the embodiment shown is rectangular, but other shapes are possible.

Curved Shank: Moving from the pivot in a proximal direction, the first and second arms 4, 6 include respective first and second curved shanks 46, 48, finger handles 18, 20, first and second elongate tangs 50, 52, and first and second proximal noses 54, 56.

The first curved shank 46 extends towards the first finger handle 18. The first superior surface 22 of the first curved shank 46 is tapered with a smooth edging. The first curved shank 46 contains a first arm stop 146. The first arm stop 146 prevents the medical tool 2 from being opened beyond a greatest extent 96. The first curved shank 46 preferably contains an oxygen tank/medical gas cylinder wrench 148 and hex bit adapter 150. The medical gas cylinder wrench 148 is a substantially rectangular-shaped orifice disposed to receive a typical compressed gas stem valve of standard medical gas cylinder size, allowing a user to quickly turn a cylinder on or off—as oxygen tank “keys” are commonly not with the tank or may be formed of a material that easily brakes. The hex bit adaptor/hexagonal key allows for insertion of standard bits.

The first inferior surface 26 of the first curved shank 46 and the second superior surface 24 of the second curved shank 48 preferably have bite walls 152 that provide grip and mechanical advantage in applying torque and can adjust around objects via the pivotally interconnecting arms 4, 6. The bite walls 152 permit longitudinal and curvilinear adjustment of the arms, allowing engagement on opposite sides of screw-type cap bodies, which are commonly found in patient care. When the arms 4, 6 are pivoted to an open position 96, the adjustable diameter between the spaces of the bite walls 152 of the first and second curved shanks 46, 48 will receive a typical jar lid, including, for example, sizes of approximately 2¾ inches in diameter, allowing a user to clamp and twist lids of various sizes open and close. The bite walls 152 preferably run the entire length of the first inferior surface 26 of the first curved shank 46 and the second superior surface 24 of the second curved shank 48, and preferably approximately one half to one third of the first inferior surface 26 of the first finger handle 18 and one quarter to one third of the second superior surface 24 of the second finger handle 20.

Preferably disposed among the bite walls are first and second angular wrench housings 154, 156, which allow for gripping around a preferably 9/16th inch and 22 mm diameter bolt and nut heads respectively. The first and second angular wrench housings 154, 156 can fit bolts slightly larger and smaller, but other size and/or additional angular wrench housings may be provided. The angular wrench housings 154, 156 may both be imperial/English measurements, may both be metric measurements, or may be a combination of imperial/English and metric measurements as shown. The angular wrench housings 154, 156 are recessed within the saw-toothed edge bite walls 152, deeper into the respective first inferior surface of the first curved shank and the second superior surface of the second curved shank than the bite walls.

The first superior surface 22 of the first curved shank 46 is preferably smooth. The second inferior surface 28 of the second curved shank 48 is also preferably smooth and contains a bottle cap remover/vial opener 158 having a preferably hook-shaped claw 160 extending into a vial opener recess 162. The vial opener 158 is preferably located proximal to the first arm stop 146 when the medical tool is in the closed position 98. The claw 160 allows users to wedge the claw 160 underneath a cap and pry it off the bottle by applying leverage force on the arms 4, 6. In addition to the first arm stop 146, a second arm second arm stop 146 may be provided to decrease the load on just a single arm stop.

Finger Handles: The first and second finger handles 18, 20 connect to the curved shanks 46, 48. Each finger handle 18, 20 is preferably ergonomically shaped for receiving a user's fingers and thumb. Preferably, the finger handles 18, 20 are configured for use by both left-handed and right-handed users.

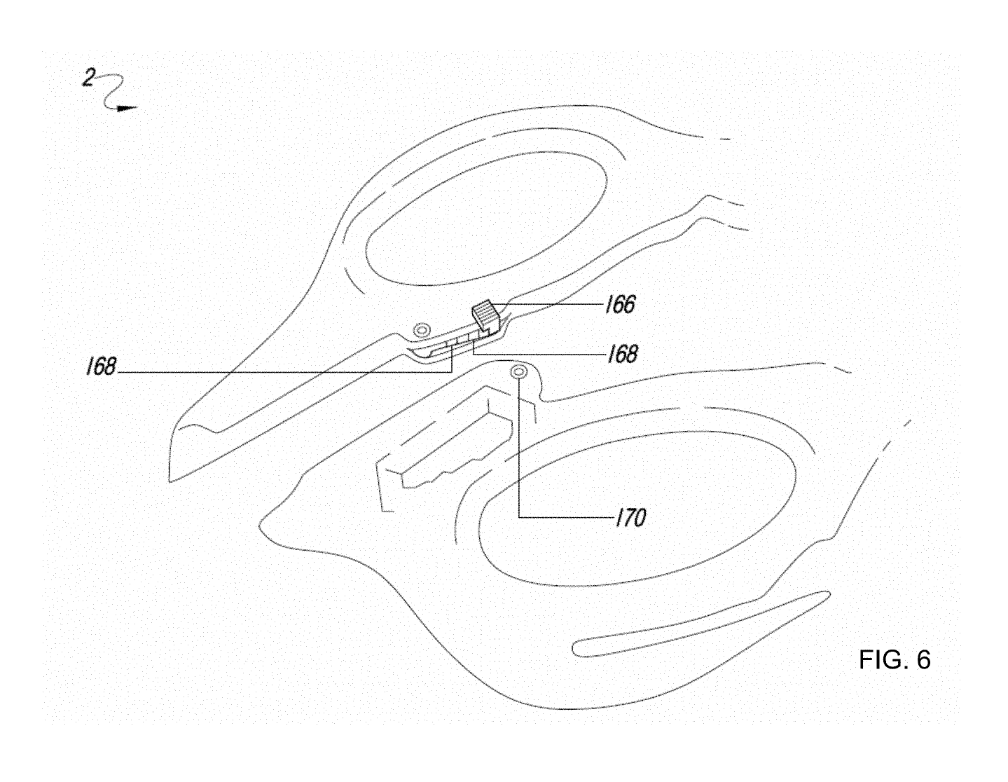

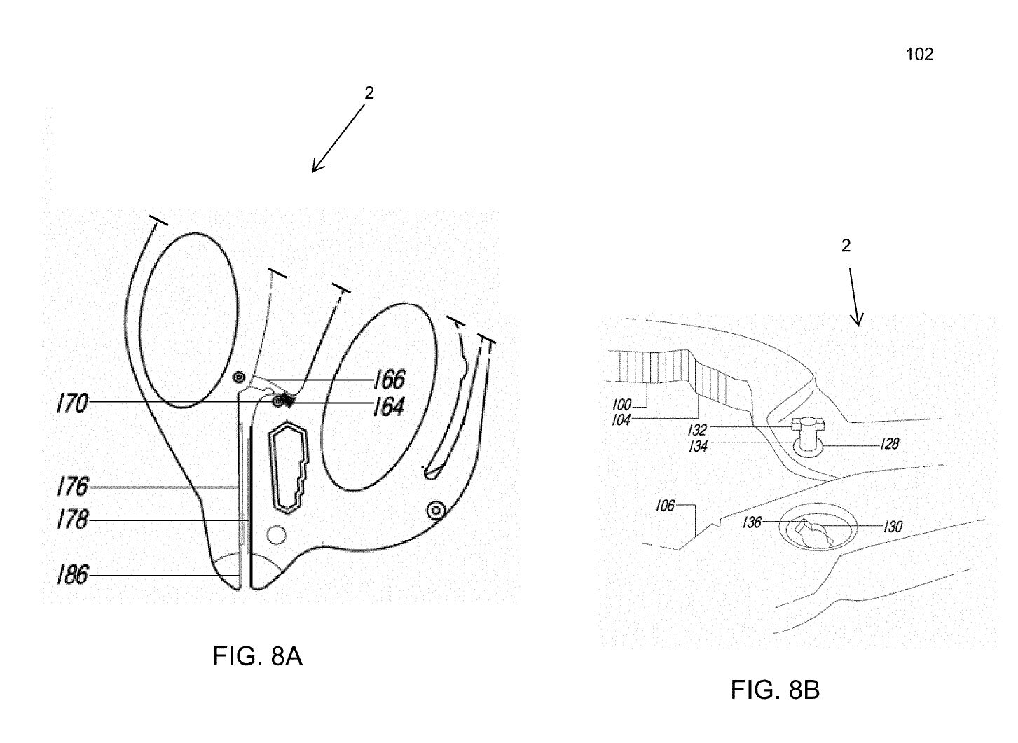

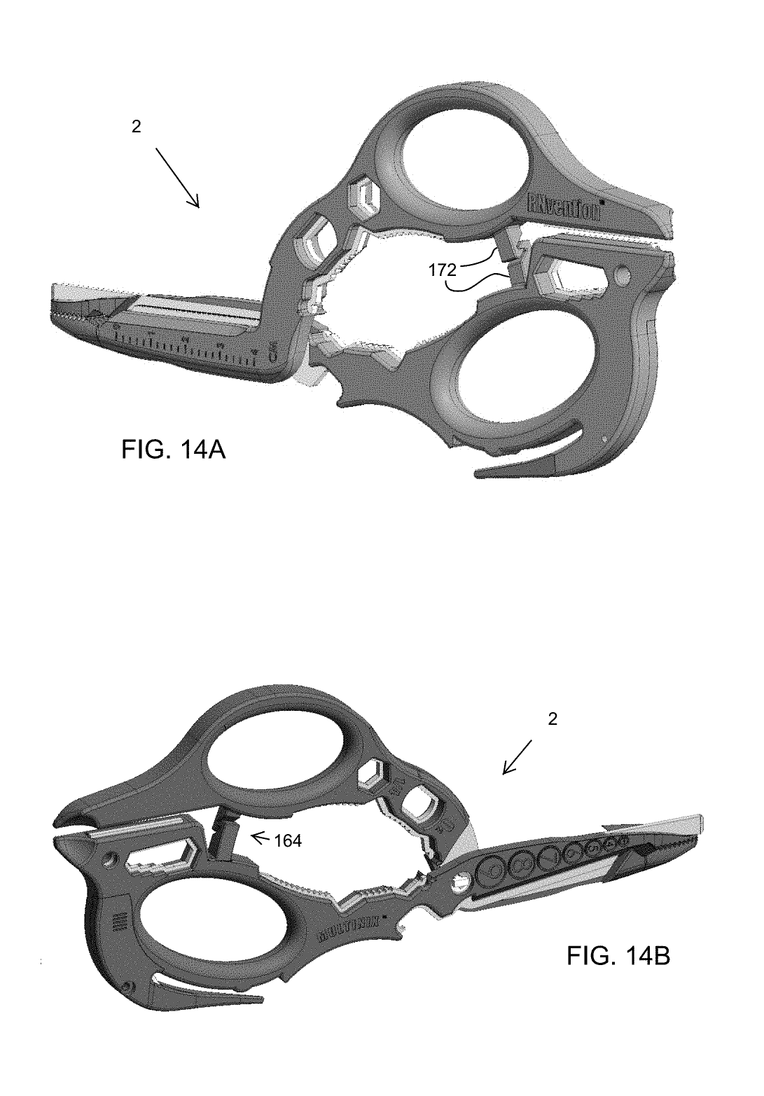

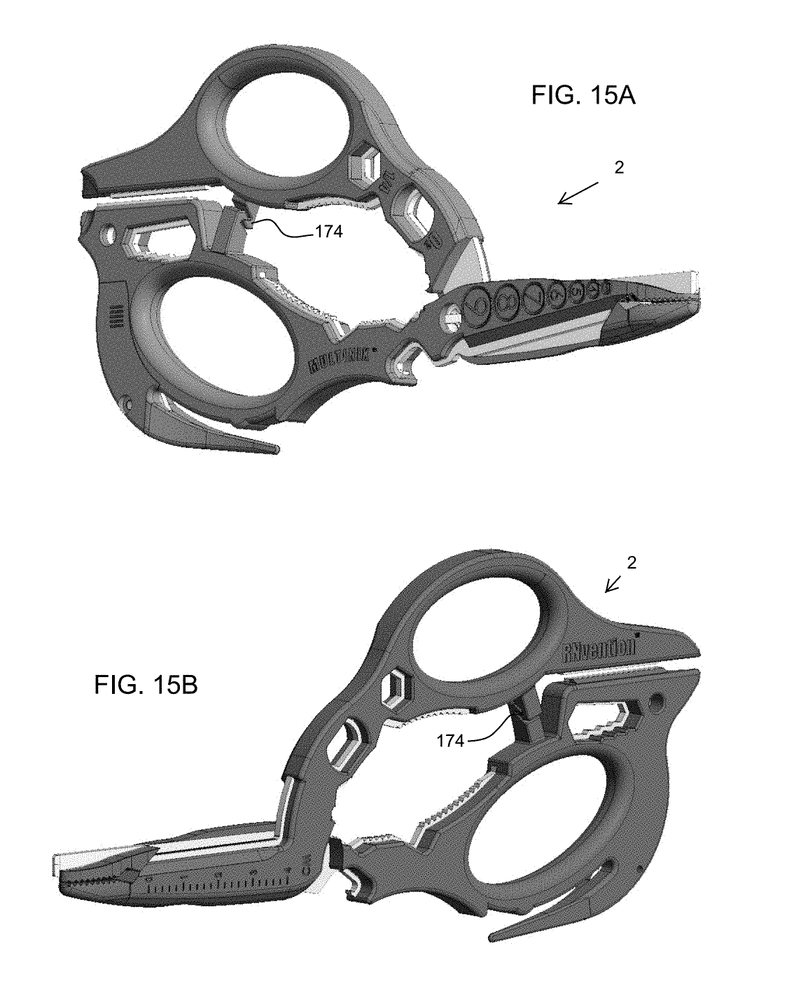

The inner surfaces of the first and second arms 4, 6, which define the first and second finger handles 18, 20, are preferably smooth. The first inferior surface 26 of the first finger handle 18 and the second superior surface 24 of the second finger handle 20 preferably have a catch 164. In the embodiment shown, and seen in FIGS. 6 and 8A, the catch arm 166 rotates about a catch pivot 167 down from the first inferior surface 26 of the first arm 4 and a catch arm recess 168 engages with a bar 170 on the superior surface on the second arm to releasably lock the medical tool in a closed position 98. There are preferably multiple catch recesses in the catch to allow the medical tool to be releasably locked in multiple closed and near closed position. In a preferred embodiment, shown in FIGS. 14A to 15B, the catch 164 comprises a pair of locking arms 172, each having one or a series of interlocking teeth or ratchets 174. The locking arms 172 preferably begin to lock when the medical tool is closed past the minimum cutting angle, or more preferably when the medical tool 2 is substantially completely closed 98. This allows the medical tool 2 to be used as shears without inadvertently locking mid use, while still providing a secure catch 164 for clamping functionality. One benefit of the locking arms 172 catch 164 embodiment is that it does not require additional moving parts on the medical tool 2, thus increasing durability. The catch 164 is designed to keep the arms 4, 6 together when not in use and to maintain a clamp on an object between the jaws 72, 84, the housing grasps 74, 86, the first and second elongate clamps 176, 178 (described below), or some combination of all three.

Elongated Tang: The first and second elongated tangs 50, 52 are connected to the respective first and second finger handles 18, 20. The first elongated tang 50 extends substantially proximal to an inferior portion of the first finger handle 18, and is disposed substantially entirely proximate to the first finger handle 18. The first elongated tang has a preferably smoothed first superior surface. The first elongate clamp 176 is disposed on the first inferior surface 26 of the first elongated tang 50.

The second elongated tang 52 extends in a superior and proximal direction from the second finger handle. The second elongated tang 52 preferably overlaps about a proximate third of the second finger handle in the proximal/distal direction, with the substantial majority of the second elongated tang superior to the second finger handle. A proximal second inferior surface of the second elongated tang 52 is smooth, with a curved pinky lever 180 to allow for pinky leverage when cutting or grasping and object. The second elongated clamp 178 is disposed on the second superior surface 24 of the second elongated tang 52. Additionally, a lanyard hole and a medial open wrench accommodating, for example four bolt/screw sizes from around ⅛″ to ¼″, are preferably defined in the second elongated tang 52.

The first and second elongated clamps 176, 178 form a clamp when the first and second arms are actuated toward one another, and the medical tool is moved from the open to closed position. The first and second elongated clamps 176, 178 provide an additional clamp on an opposite side of the pivot as the jaws 72, 84 and the housing grasps 74, 86. The first and second elongated clamps 176, 178 are preferably proximal to the catch 164 and substantially proximal to the first and second finger handles 18, 20. The elongated clamps form proximal clamps, on an opposite side of the pivot from the distal clamps.

The first and second elongated tangs 50, 52 provide mechanical advantage, for example, when the medical tool 2 is placed in between objects such as tubing, with the elongate tangs 50, 52 inserted over an object, whereby a rotation of the arms 4, 6 squeezing elongated clamps 176, 178 towards each other, exerts a force that levers tubes apart.

Proximal Noses: The sinister surfaces 34, 36 of a terminal proximal portion of the first and second elongated tangs 50, 52 are preferably flat and smooth. The terminal proximal ends of the dexter surfaces 30, 32 of the first and second elongated tangs 50, 52 transition to the first and second proximal noses 54, 56 respectively. The proximal noses 54, 56 are preferably concaved or cupped transitioning from the first and second elongated tangs 50, 52 to a first and second terminal proximal tip 186, 188. The proximal noses 54, 56 aid in scraping materials such as tape off a piece of equipment. When the medical tool 2 is oriented in a substantially perpendicular angle to a table or other flat surface, the terminal proximal tips 186, 188 of the proximal noses 54, 56 can be used as calipers suitable for transferring distances between points on a chart to an associated measurement scale.

Hip: As described above, a hip 58 is preferably located adjacent to an inferior proximal end of the second finger handle 20. The hip 58 contains the recessed knife 60, including the knife housing 62, the knife blade 64, the knife housing plate 66, and the retainer 68, and the clasp 70.

The knife blade 64 is preferably a removable #12 curved suture blade insert, for example. The knife blade 64 can be more than one blade and the blade can have multiple angles. The clasp 70 serves for clamping on a pocket or allowing to slide over and between materials.

As described above, the medical tool 2 may include differing materials. The medical tool is preferably made from stainless steel. However, any suitable material or materials can be used, including polymers, antibacterial plastics and/or magnetizing metals. One or both of the arms 4, 6 may also contain radio frequency identification or similar technology to identify and track location of medical tool 2.

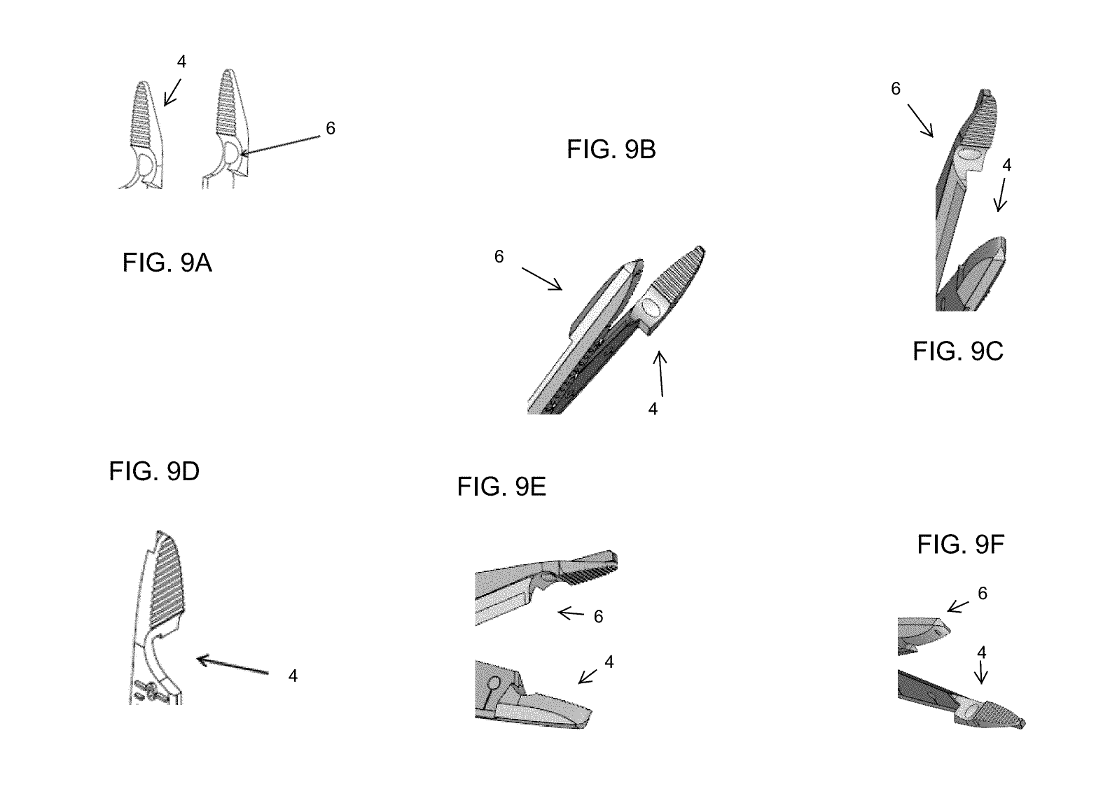

Further alternative embodiments of the medical tool 2 are shown in FIGS. 9A to 13F.

The invention illustratively disclosed herein suitably may explicitly be practiced in the absence of any element which is not specifically disclosed herein. While various embodiments of the present invention have been described in detail, it is apparent that various modifications and alterations of those embodiments will occur to and be readily apparent those skilled in the art. However, it is to be expressly understood that such modifications and alterations are within the scope and spirit of the present invention, as set forth in the appended claims. Further, the invention(s) described herein is capable of other embodiments and of being practiced or of being carried out in various other related ways. In addition, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items while only the terms “consisting of” and “consisting only of” are to be construed in the limitative sense.

Wherefore, I/we claim:

1. A medical tool comprising:
a first arm and a second arm attached at a pivot;
a proximal clamp on a proximal side of the pivot;
a distal clamp on a distal side of the pivot; and
a first and a second distal tang blade spacing the distal clamp from the pivot.

2. The medical tool of claim 1 further comprising a terminal blade protruding on a distal end of one of the first arm, the second arm, and both the first and the second arm.

3. The medical tool of claim 1 further comprising a recessed knife attached to a hip, the hip being adjacent one of a first finger handle, a second finger handle, and both the first and the second finger handle.

4. The medical tool of claim 1 wherein the distal clamp includes a first jaw on the first arm and a second jaw on the second arm, with each of the first and second jaw at least partially contacting one another when the medical tool is in a closed position.

5. The medical tool of claim 1 wherein the distal clamp includes a first housing grasp on the first arm and a second housing grasp on the second arm, with each of the first and second jaw at least partially contacting one another when the medical tool is in a closed position.

6. The medical tool of claim 5 wherein the first and second housing grasp form a quadrilateral shaped grasp aperture.

7. The medical tool of claim 5 wherein the distal clamp further comprises a first housing grasp on the first arm and a second housing grasp on the second arm, with each of the first and second jaw at least partially contacting one another when the medical tool is in a closed position.

8. The medical tool of claim 1 wherein one of distal and proximal portions of one of the first and second arms contains a graduated first surface display to aid in measurement.

9. The medical tool of claim 1 wherein one of the distal and proximal portions of the first arm contains a graduated first surface display to aid in measurement, and one of the distal and proximal portions of the second arm contains a graduated second display to aid in measurement.

10. The medical tool of claim 1 further comprising a vial opener being disposed on one of the first and the second arms.

11. The medical tool of claim 1 further comprising one of a gas cylinder wrench, a hex bit adaptor, and both the gas cylinder wrench and the hex bit adapter being defined in a proximal region of one of the first and the second arms.

12. The medical tool of claim 1 further comprising one of a first shield, a second shield, and the first and the second shield on a distal region of one of the first and the second arms to aid in preventing inadvertently shearing a material being clamped by the distal clamp.

13. The medical tool of claim 12 wherein the shield blocks material from the entering between the distal tang blades until the medical tool is opened past a minimum cutting angle.

14. The medical tool of claim 1 further comprising a catch which releasable retains the medical tool in a closed position.

15. The medical tool of claim 14 wherein the catch comprises a catch arm attached to the first arm that engages a bar attached to the second arm in a catch arm recess.

16. The medical tool of claim 14 wherein the catch comprises a pair of locking arms with one or more releasably interlocking ratchets on each locking arm.

17. The medical tool of claim 1 further comprising a one of bite walls, angular wrench housing, and both bite walls and angular wrench housing disposed on respective inferior and superior surfaces of the first and second arms on the proximal side of the pivot.

18. The medical tool of claim 1 further comprising a medial open wrench defined in one of the first and second arms with contours to engage a plurality of nut sizes.

19. A medical tool comprising:
a first arm and a second arm attached at a pivot;
a distal clamp on the first and second arm on a distal side of the pivot;
a first and a second distal tang blade spacing the distal clamp from the pivot, and
a first shield on the first arm spaced between the distal clamp and the first distal tang blade, the first shield aiding in preventing inadvertently shearing a material being clamped by the distal clamp.

20. A medical tool comprising:
a first arm and a second arm attached at a pivot;
a proximal clamp on a proximal side of the pivot;
a distal clamp on a distal side of the pivot;
a first and a second distal tang blade spacing the distal clamp from the pivot;
a terminal blade protruding on a distal end of the first arm;
a recessed knife attached to a hip, the hip being adjacent one of a first finger handle, a second finger handle, and both the first and the second finger handle;
the distal clamp including
a first housing grasp on the first arm and a second housing grasp on the second arm, with each of the first and second jaw at least partially contacting one another when the medical tool is in a closed position, the first and second housing grasp forming a quadrilateral shaped grasp aperture and,
a jaw on the first arm and a second jaw on the second arm, with each of the first and second jaw at least partially contacting one another when the medical tool is in a closed position;
a vial opener being disposed on one of the first and the second arms;
one of a gas cylinder wrench, a hex bit adaptor, and both the gas cylinder wrench and the hex bit adapter being defined in a proximal region of one of the first and the second arms; and
one of a first shield, a second shield, and the first and the second shield on a distal region of one of the first and the second arms to aid in preventing inadvertently shearing a material being clamped by the distal clamp.
